(19) United States
(12) Patent Application Publication
(10) Pub. No.: US 2001/0021642 A1
(43) Pub. Date: Sep. 13, 2001

(54) Mobile telecommunication system and hand-off method of radio speech paths at the system

(76) Inventor: Nobuhiko Iida, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/801,658

(22) Filed: Mar. 9, 2001

(30) Foreign Application Priority Data
Mar. 13, 2000 (JP) 068692/2000

(51) Int. Cl. H04B 1/10

(52) U.S. Cl. 455/67.1; 455/67.3; 455/63

(57) ABSTRACT

A mobile telecommunication system and a hand-off method of radio speech paths at the system, in which radio resources in the system can be used efficiently, are provided. A radio base station controller in the system monitors FERs (frame error rates) of upstream radio speech paths of radio speech paths using between a mobile telecommunication terminal in a service area overlapped service areas of plural radio base stations and the plural radio base stations in a predetermined constant cycle. At the case that some radio speech paths whose FERs exceeded a frame quality threshold value exist, the best frame is selected from the radio speech paths excluded the radio speech paths whose FERs exceeded the frame quality threshold value, and the FER measured result of the selected best frame is obtained. And when the FER measured result of the selected best frame from the radio speech paths excluded the radio speech paths whose FERs exceeded the frame quality threshold value is equal to the FER measured result of the selected best frame from all radio speech paths, downstream speech levels of the radio speech paths excluded the radio speech paths whose FERs exceeded the frame quality threshold value are monitored by electric field strength of pilot signals of the downstream radio speech paths. And the downstream speech levels are compared with a speech level threshold value. And when some radio speech paths whose speech levels exceeded the speech level threshold value exist, the radio speech paths whose FERs exceeded the frame quality threshold value are dropped as a hand-off.

### BACKGROUND OF THE INVENTION

The present invention relates to a mobile telecommunication system and a hand-off method of radio speech paths at the system, in particular, in which interference among the radio speech paths using between radio base stations and a mobile telecommunication terminal is reduced and processes at the radio base stations and a radio base station controller are reduced.

### DESCRIPTION OF THE RELATED ART

Referring to drawings, a conventional mobile telecommunication system is explained. FIG. 1 is a diagram showing a system structure of a conventional CDMA (code division multiple access) mobile telecommunication system. FIG. 2 is a diagram showing quality data of each of radio speech paths between each of radio base stations and a mobile telecommunication terminal and also showing a using state of each of the radio speech paths, at the system shown in FIG. 1, in a time series. In FIG. 2, (a) shows changes of electric field strength of pilot signals at each of the radio speech paths, and (b) shows a using state of each of the radio speech paths based on the result shown in (a).

Referring to FIGS. 1 and 2, a drop of a radio speech path by a hand-off at the conventional CDMA telecommunication system specified at the TIA (Telecommunications Industry Association)/EIA (Electronic Industry Association) IS (Interim Standard) -95 is explained.

As shown in FIG. 1, the conventional CDMA mobile telecommunication system consists of a mobile telecommunication terminal 1a using by a subscriber, radio base stations 10a, 20a, and 30a, which establish telecommunication with the mobile telecommunication terminal 1a in a service area overlapped service areas of the radio base stations 10a, 20a, and 30a, and a radio base station controller 100a that establishes telecommunication with the radio base stations 10a, 20a, and 30a by using wire transmission lines 13a, 23a, and 33a and controls to make the mobile telecommunication terminal 1a using by the subscriber connect with a subscriber at a public telephone network or a subscriber at the mobile telecommunication system, and also controls to switch speech paths to a subscriber at a public telephone network or a subscriber at the mobile telecommunication system. In FIG. 1, in order to make the explanation concise, the number of the mobile telecommunication terminals is made to be one, and the number of the radio base stations is made to be three, however the number is not limited to the number mentioned above.

In FIG. 1, the mobile telecommunication terminal 1a is in the service area overlapped the service areas 12a, 22a, and 32a of the respective radio base stations 10a, 20a, and 30a, and establishes the telecommunication with the radio base stations 10a, 20a, and 30a, by radio speech paths 11a, 21a, and 31a. And also a Pilot (1a) 14a signifying electric field strength of a pilot signal of the radio speech path 11a between the radio base station 10a and the mobile telecommunication terminal 1a exists. And a Pilot (2a) 24a signifying electric field strength of a pilot signal of the radio speech path 21a between the radio base station 20a and the mobile telecommunication terminal 1a exists. And a Pilot (3a) 34a signifying electric field strength of a pilot signal of the radio speech path 31a between the radio base station 30a and the mobile telecommunication terminal 1a exists.

At the time T1 shown in FIG. 2 (a), when the Pilot (2a) 24a becomes lower than a threshold value T_DROP 51 signifying to drop a radio speech path, the mobile telecommunication terminal 1a detects this, and transmits a hand-off request signifying to drop the radio speech path 21a between the mobile telecommunication terminal 1a and the radio base station 20a to the radio base station controller 100a through the radio base station 20a. The radio base station controller 100a, received the hand-off request, transmits an instruction executing the hand-off to the mobile telecommunication terminal 1a. And the mobile telecommunication terminal 1a drops the radio speech path 21a connecting to the radio base station 20a, after received the instruction executing the hand-off.

At the time T1, as shown in FIG. 2 (a), the Pilot (1a) 14a signifying the electric field strength of the pilot signal of the radio speech path 11a between the radio base station 10a and the mobile telecommunication terminal 1a is not lower than the T_DROP 51. And also the Pilot (3a) 34a signifying the electric field strength of the pilot signal of the radio speech path 31a between the radio base station 30a and the mobile telecommunication terminal 1a is not lower than the T_DROP 51. Therefore, as shown in FIG. 2 (b), the radio speech paths 11a, and 31a are Active signifying the using state. And the radio speech path 21a, between the mobile telecommunication terminal 1a and the radio base station 20a, executed the hand-off caused by that the Pilot (2a) 24a became lower than the T_DROP 51, was dropped and was changed to Neighbor signifying a hand-off candidate, from Active.

And at the time T2 shown in FIG. 2 (a), when the Pilot (2a) 24a becomes higher than a threshold value T_ADD 52 signifying to add a radio speech path, the mobile telecommunication terminal 1a detects this, and transmits a hand-off request signifying to add the radio speech path 21a between the mobile telecommunication terminal 1a and the radio base station 20a to the radio base station controller 100a through the radio base station 20a.

The radio base station controller 100a, received the hand-off request, transmits an instruction executing the hand-off to the mobile telecommunication terminal 1a. And the mobile telecommunication terminal 1a adds the radio speech path 21a between the mobile telecommunication terminal 1a and the radio base station 20a, after received the instruction executing the hand-off.

As mentioned above, at the time T2, as shown in FIG. 2 (a), the Pilot (1a) 14a signifying the electric field strength of the pilot signal of the radio speech path 11a between the radio base station 10a and the mobile telecommunication terminal 1a is not lower than the T_DROP 51. And also the Pilot (3a) 34a signifying the electric field strength of the pilot signal of the radio speech path 31a between the radio base station 30a and the mobile telecommunication terminal 1a is not lower than the T_DROP 51. Therefore, as shown in FIG. 2 (b), the radio speech paths 11a, and 31a are still Active signifying the using state. And the radio speech path 21a, between the mobile telecommunication terminal 1a and the radio base station 20a, executed the hand-off generated by that the Pilot (2a) 24a became higher than the T_ADD 52, is added and is changed to Active from Neighbor.

As mentioned above, at the conventional CDMA mobile telecommunication system, a radio speech path between a radio base station and a mobile telecommunication terminal is added or dropped by electric field strength of a downstream radio speech path between the radio base station and the mobile telecommunication terminal.

Next, referring to a drawing, a hand-off method of another conventional mobile telecommunication system is explained. FIG. 3 is a diagram showing a system structure of another conventional mobile telecommunication system. FIG. 4 is a flowchart showing the hand-off method of another conventional mobile telecommunication system shown in FIG. 3. This conventional mobile telecommunication system is described in the Japanese Patent Application Laid-Open No. HEI 10-79985.

As shown in FIG. 3, at this conventional mobile telecommunication system, a radio telecommunication network 120 provides a mobile switching center 102, and plural cell sites 104 including radio base stations 105 connected to a base site controllers 106. And a mobile unit such as mobile telecommunication equipment 108 and a mobile telecommunication terminal 110 executes telecommunication with the radio base station 105 connected to the base site controller 106. And the mobile unit executes the telecommunication with a destination mobile unit or a destination wire unit connected to a wire telecommunication network.

Referring to FIG. 4, operation of the hand-off method of this conventional mobile telecommunication system is explained. First, normal telecommunication is executed between a mobile unit and the mobile telecommunication network 120 (step 404), during this normal telecommunication, it is judged whether the telecommunication was suspended or not (step 406). Generally, the telecommunication is suspended or interrupted, when a BER (bit error rate) or a FER (frame error rate) exceeded a designated value, in this, the BER or the FER is calculated by, for example, a control circuit. When the telecommunication was suspended (YES at the step 406), the mobile unit suspends its speech and decodes BSICs (base station ID codes) of adjacent cell sites 104 (step 408). The radio base station 105 executing service for the mobile unit judges whether a stronger radio base station in the radio telecommunication network 120 can be used or not instead of the executing radio base station 105 (step 410). The mobile unit can judge that the stronger radio base station can be used by keeping a list of electric field strength of new radio base stations. Or the radio base station 105 can inform the mobile unit of the stronger radio base stations by that the radio base station 105 transmits a signal to the mobile unit. When the stronger radio base station can be used, the mobile unit transmits a message to the base site controller 106, and requests hand-off (step 412). And the hand-off is executed by an existing technology (step 414).

At the conventional CDMA mobile telecommunication system, the service area of each of the radio base stations in the CDMA mobile telecommunication system is designed so that each of the mobile telecommunication terminals can keep sufficient service quality, however, radio resources at each of the radio base stations are limited. At the radio speech paths being one of the radio resources, the radio speech paths are dropped or added, based on the electric field strength (signal level) of the downstream radio speech paths between the radio base stations and the mobile telecommunication terminal. At the case that plural radio speech paths are used between the radio base stations and the mobile telecommunication terminal, the radio base station controller selects a best frame in all frames received from the radio speech paths and handles the measured result FER of this selected frame as the FER of the mobile telecommunication terminal. Consequently, the radio speech paths, which do not influence the speech quality even if these radio speech paths are disconnected, exist in a state that these radio speech paths are not disconnected. Therefore there is a problem that a load processing frames receiving from these not selected radio speech paths is applied to the radio base station controller. Moreover, there is a problem that the speech quality in the mobile telecommunication system is deteriorated because of that interference occurs by using these not selected radio speech paths. Furthermore, there is a problem that the using efficiency of the radio resources is bad, because the not selected radio speech paths can not be allocated to the other mobile telecommunication terminals.

### SUMMARY OF THE INVENTION

It is therefore an object of the present invention to provide a mobile telecommunication system and a hand-off method of radio speech paths at the system, in which interference among the radio speech paths using between radio base stations and a mobile telecommunication terminal is reduced and processes at the radio base station and a radio base station controller are reduced. At the mobile telecommunication system of the present invention that provides telecommunication service for the mobile telecommunication terminals, radio speech paths can be dropped when FERs become bad in addition to that downstream speech levels become bad. First, upstream speech quality of upstream radio speech paths is monitored by their FERs, and when some of the FERs exceeded a frame quality threshold value, a best frame is selected from received upstream radio speech paths excluded the upstream radio speech paths whose FERs exceeded the frame quality threshold value. And it is judged that the upstream radio speech quality is secured by the measured result of the FER of the selected frame. Further, downstream speech levels in the downstream radio speech paths excluded the radio speech path whose FERs exceeded the frame quality threshold value are monitored, and when the downstream radio speech paths whose downstream speech levels exceed a speech level threshold value exist, the radio speech paths whose FERs exceeded the frame quality threshold value are dropped. With this, the mobile telecommunication system having high using efficiency of the radio resources can be provided.

According to a first aspect of the present invention, there is provided a mobile telecommunication system, which provides plural radio base stations having a respective individual service area, plural mobile telecommunication terminals existing in the service areas, and a radio base station controller that controls the plural radio base stations, and provides telecommunication service to the plural mobile telecommunication terminals. And at the case that one of the plural mobile telecommunication terminals is in a service area overlapped the plural service areas of the plural radio base stations, and plural radio speech paths between the one of the plural mobile telecommunication terminals and the plural radio base stations, which manage their individual service areas and are the bases of the overlapped service area, are formed, the radio base station controller provides a monitoring means for monitoring FERs (frame error rates) signifying frame quality of respective upstream radio speech paths of the plural radio speech paths for the one of the plural mobile telecommunication terminals in a predetermined constant cycle, and a judging means, which detects some radio speech paths whose FERs of the upstream radio speech paths exceeded a predetermined frame quality threshold value based on monitored results at the monitoring means, in order to judge that speech quality of several upstream radio speech paths in all the plural radio speech paths using between the one of the plural mobile telecommunication terminals and the plural radio base stations can be sufficiently secured, and removes the upstream radio speech paths, whose FERs exceeded the frame quality threshold value, from the plural radio speech paths using between the one of the plural mobile telecommunication terminals and the plural radio base stations, and selects the best frames from the upstream radio speech paths removed radio speech paths exceeded the frame quality threshold value, and judges whether the upstream radio speech paths of the one of the plural mobile telecommunication terminals can be secured or not by using the measured result of the FERs from the selected best frames.

According to a second aspect of the present invention, in the first aspect, the radio base station controller further provides a storing means for storing information of the upstream radio speech paths whose FERs exceeded the frame quality threshold value in a designated table, when upstream radio speech quality of the one of the plural mobile telecommunication terminals is judged to be able to secure even if the upstream radio speech paths whose FERs exceeded the frame quality threshold value are removed from all the upstream radio speech paths using between the one of the plural mobile telecommunication terminals and the plural radio base stations.

According to a third aspect of the present invention, in the second aspect, the radio base station controller further provides a speech level confirming means for confirming speech levels of downstream radio speech paths of remaining all the radio speech paths removed the radio speech paths whose FERs exceeded the frame quality threshold value by referring to the designated table by electric field strength of pilot signals transmitted from the plural radio base stations connected to the one of the plural mobile telecommunication terminals, when the designated table in the storing means, which stores the information of the upstream radio speech paths whose FERs exceeded the frame quality threshold value, is renewed, and a control means for judging that the downstream radio speech level of the one of the plural mobile telecommunication terminals can be secured even if the radio speech paths whose FERs exceeded the frame quality threshold value are removed, at the case that at least one radio speech path whose electric field strength of the pilot signal exceeded a predetermined speech level threshold value exists in the downstream radio speech paths.

According to a fourth aspect of the present invention, in the third aspect, the radio base station controller further provides a radio speech path dropping means for dropping the radio speech paths whose FERs exceeded the frame quality threshold value as a hand-off based on the information of the radio speech paths whose FERs exceeded the frame quality threshold value stored in the designated table in the storing means, by judging that the downstream radio speech path of the one of the plural mobile telecommunication terminals can be secured even if the radio speech paths whose FERs exceeded the frame quality threshold value are removed, at the case that at least one radio speech path whose electric field strength of the pilot signal exceeded the predetermined speech level threshold value exists in the remaining downstream radio speech paths, excluded the radio speech paths whose FERs exceeded the frame quality threshold value, using between the one of the plural mobile telecommunication terminals and the plural radio base stations.

According to a fifth aspect of the present invention, there is provided a mobile telecommunication system, which provides plural radio base stations having a respective individual service area, plural mobile telecommunication terminals existing in the service areas, and a radio base station controller that controls the plural radio base stations, and provides telecommunication service to the plural mobile telecommunication terminals. And the radio base station controller provided a signal transmitter and receiver that transmits and receives information regarding speech signals and control signals to and from the plural radio base stations through respective wire transmission lines, a radio speech path controller that memorizes a predetermined frame quality threshold value for securing speech quality and monitors FERs of respective upstream radio speech paths of plural radio speech paths through the signal transmitter and receiver in a predetermined cycle, and compares the monitored FERs with the frame quality threshold value, and outputs the compared results, in order to control the plural radio speech paths at the case that the plural radio speech paths are established between one of the plural mobile telecommunication terminal in a service area overlapped the service areas and the plural radio base stations managing the respective service areas that are bases of the overlapped service area, a controller that memorizes a predetermined speech level threshold value, and compares electric field strength of pilot signals of downstream radio speech paths of the plural radio speech paths with the predetermined speech level threshold value in order to secure speech quality, only when radio speech paths whose FERs exceeded the frame quality threshold value exist in the plural radio speech paths at the compared results at the radio speech path controller, and decides that a radio speech path whose FER is the worst is as a hand-off by the jointed compared results of the compared result of the FERs at the radio speech path controller and the compared result of the electric field strength at the controller, and outputs the decided result, radio speech path information storage that memorizes the using state of the plural radio speech paths in a designated table in a time series by the control of the controller, and a control signal controller that transmits a control signal signifying the hand-off to radio base stations having a radio speech path that is decided to be hand-off at the controller through the signal transmitter and receiver.

According to a sixth aspect of the present invention, there is provided a hand-off method of radio speech paths at a mobile telecommunication system, which provides plural radio base stations having a respective individual service area, plural mobile telecommunication terminals existing in the service areas, and a radio base station controller that controls the plural radio base stations, and provides telecommunication service to the plural mobile telecommunication terminals. And the radio base station controller provides the steps of, at the case that plural radio speech paths are established between one of the plural mobile telecommunication terminal in a service area overlapped the service areas and the plural radio base stations managing the respective service areas that are bases of the overlapped service area, monitoring upstream speech quality of upstream radio speech paths of plural radio speech paths for the one of the plural mobile telecommunication terminals by their FERs in a predetermined cycle, comparing the monitored FERs with a predetermined frame quality threshold value, selecting the best frames of upstream radio speech paths whose FERs did not exceed the predetermined frame quality threshold value when the FERs of some of the upstream radio speech paths exceeded the predetermined frame quality threshold value, judging that radio speech path quality of the upstream radio speech paths of the one of the plural mobile telecommunication terminals can be secured by the measured result of the FERs from the selected frames, storing information of the radio speech paths whose FERs exceeded the frame quality threshold value in a designated table, monitoring downstream speech levels of downstream radio speech paths of the plural radio speech paths excluded the radio speech paths whose FERs exceeded the frame quality threshold value for the one of the plural mobile telecommunication terminals by measuring electric field strength of pilot signals transmitted from the plural radio base stations only when a radio speech path whose FER exceeded the frame quality threshold value exists, comparing the electric field strength of the pilot signals of remaining plural radio speech paths excluded the radio speech paths whose FERs exceeded the frame quality threshold value with a predetermined speech level threshold value, judging that the downstream radio speech level of the one of the plural mobile telecommunication terminals can be secured even if the radio speech paths whose FERs exceeded the frame quality threshold value are removed, at the case that at least one radio speech path whose electric field strength of the pilot signal exceeded the predetermined speech level threshold value exists in the downstream radio speech paths, and dropping the radio speech paths whose FERs exceeded the frame quality threshold value as the hand-off, based on the information stored in the designated table.

### BRIEF DESCRIPTION OF THE DRAWINGS

The objects and features of the present invention will become more apparent from the consideration of the following detailed description taken in conjunction with the accompanying drawings in which:

FIG. 1 is a diagram showing a system structure of a conventional CDMA (code division multiple access) mobile telecommunication system;

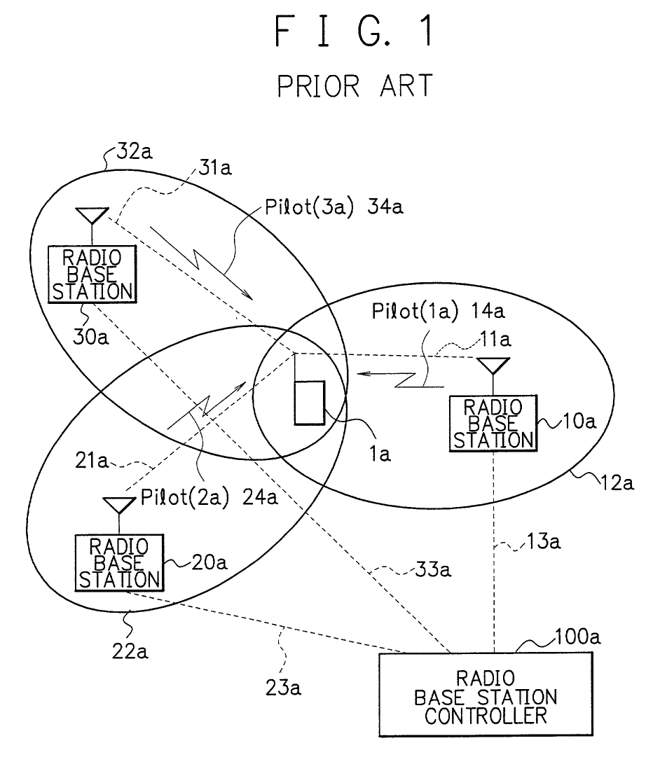

FIG. 2 is a diagram showing quality data of each of radio speech paths between each of radio base stations and a mobile telecommunication terminal and also showing a using state of each of the radio speech paths, at the system shown in FIG. 1, in a time series;

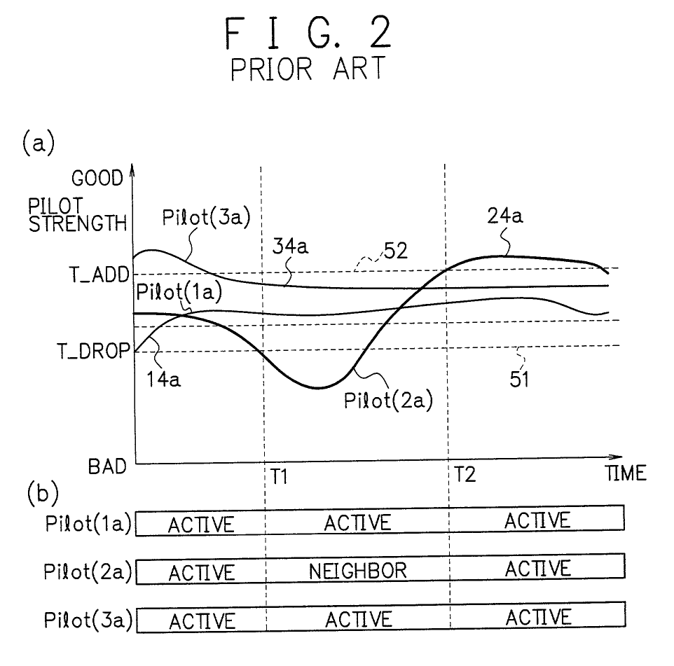

FIG. 3 is a diagram showing a system structure of another conventional mobile telecommunication system;

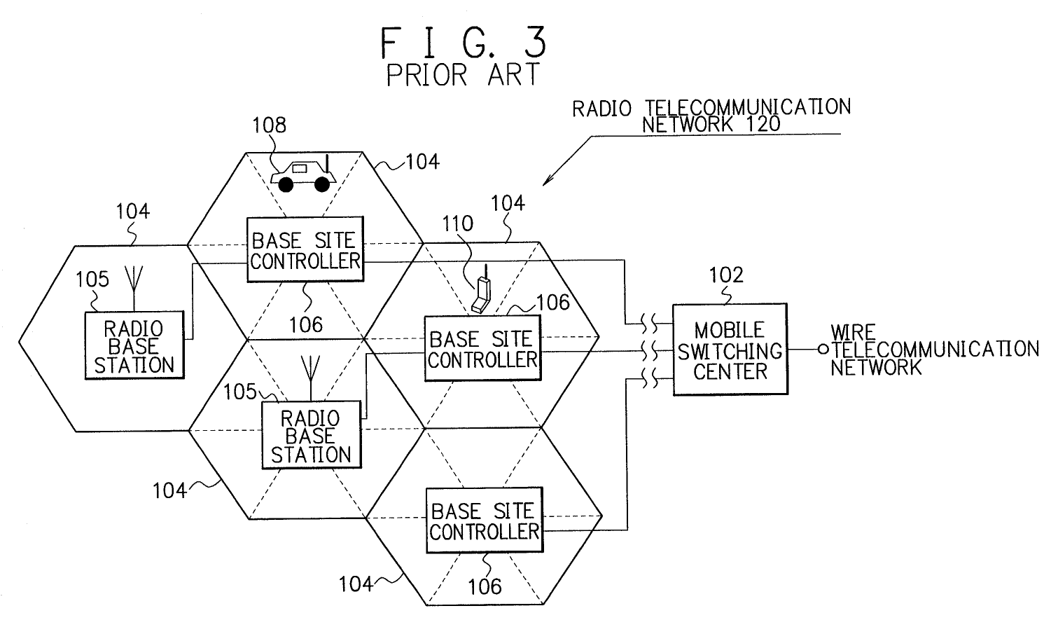

FIG. 4 is a flowchart showing a hand-off method of another conventional mobile telecommunication system shown in FIG. 3;

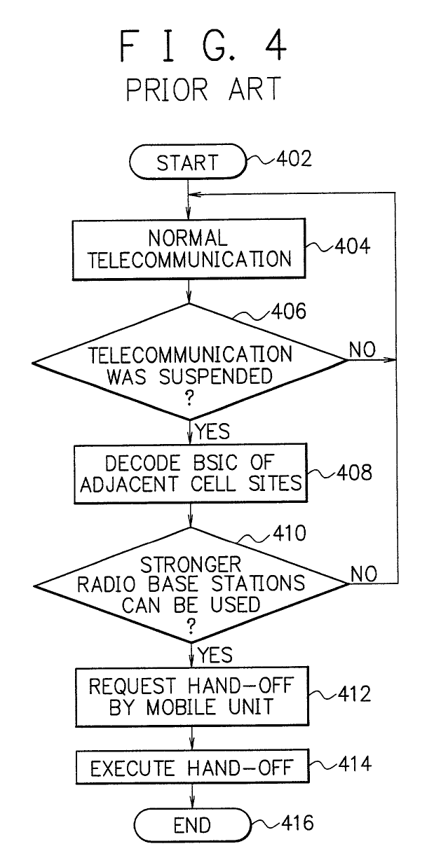

FIG. 5 is a diagram showing a system structure of an embodiment of a CDMA mobile telecommunication system of the present invention;

FIG. 6 is a block diagram showing a radio base station controller at the embodiment of the CDMA mobile telecommunication system of the present invention;

FIG. 7 is a diagram showing quality data of each of the radio speech paths between each of the radio base stations and a mobile telecommunication terminal and also showing a using state of each of the radio speech paths, in a time series at the embodiment of the CDMA mobile telecommunication system of the present invention; and

FIG. 8 is a flowchart showing processes of hand-off control at the radio base station controller of the embodiment of the CDMA mobile telecommunication system of the present invention.

### DESCRIPTION OF THE PREFERRED EMBODIMENT

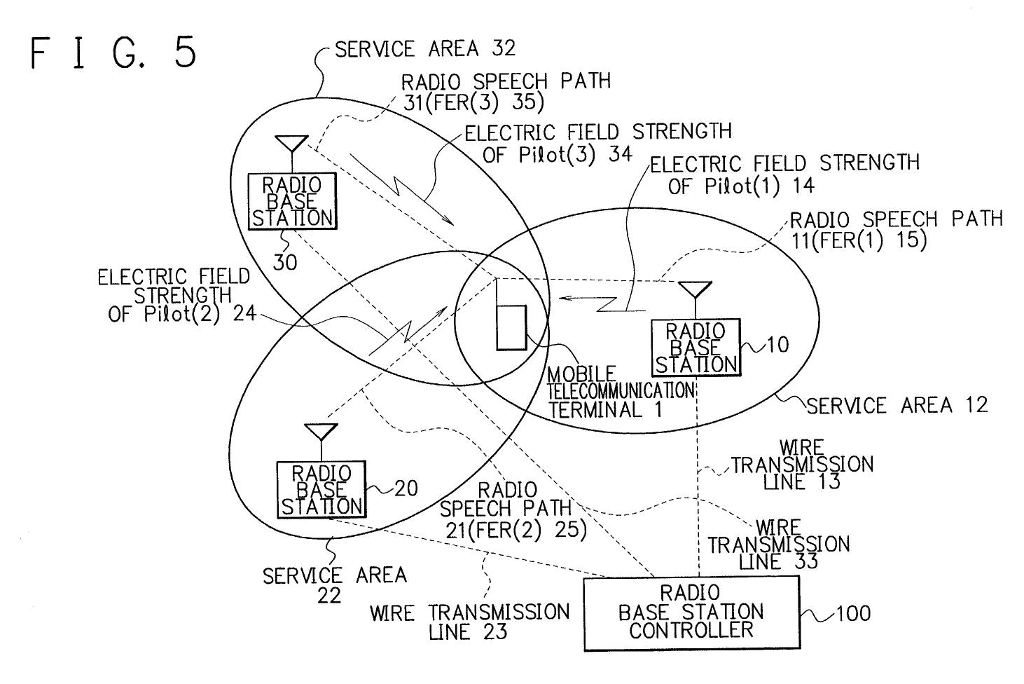

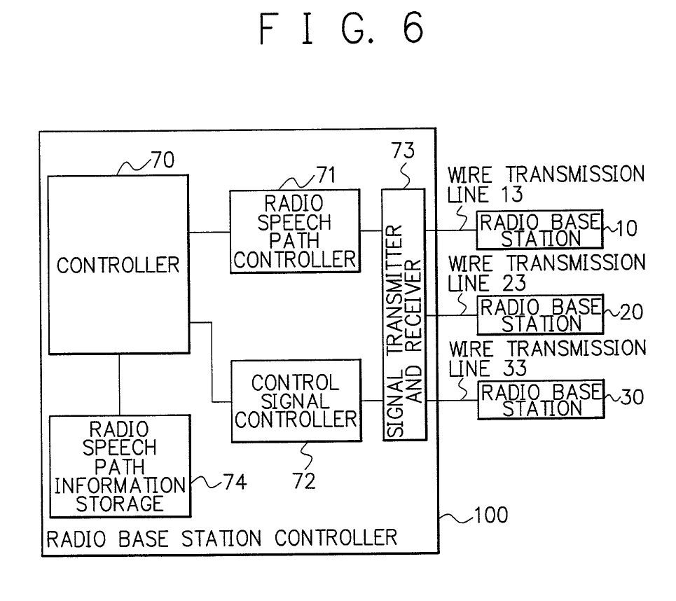

Referring now to the drawings, an embodiment of the present invention is explained in detail. FIG. 5 is a diagram showing a system structure of the embodiment of a CDMA mobile telecommunication system of the present invention. FIG. 6 is a block diagram showing a radio base station controller at the embodiment of the CDMA mobile telecommunication system of the present invention.

As shown in FIG. 5, the embodiment of the CDMA mobile telecommunication system of the present invention consists of a mobile telecommunication terminal 1 using by a subscriber, radio base stations 10, 20, and 30, which establish telecommunication with the mobile telecommunication terminal 1 in a service area overlapped service areas of the radio base stations 10, 20, and 30, and a radio base station controller 100 that establishes telecommunication with the radio base stations 10, 20, and 30 by using wire transmission lines 13, 23, and 33 and controls to make the mobile telecommunication terminal 1 using by the subscriber connect with a telecommunication terminal of a subscriber at a public telephone network or a mobile telecommunication terminal of a subscriber at the mobile telecommunication system, and also controls to switch the speech paths to a telecommunication terminal of a subscriber at a public telephone network or a mobile telecommunication terminal of a subscriber at the mobile telecommunication system.

In FIG. 5, in order to make the explanation concise, the number of the mobile telecommunication terminals is made to be one, and the number of the radio base stations is made to be three, however the number is not limited to the number mentioned above.

In FIG. 5, the mobile telecommunication terminal 1 is in the service area that is overlapped by the service areas 12, 22, and 32 provided by the respective radio base stations 10, 20, and 30, and establishes telecommunication with the radio base stations 10, 20, and 30 by respective radio speech paths 11, 21, and 31. And also a Pilot (1) 14 signifying electric field strength of a pilot signal of the radio speech path 11 between the radio base station 10 and the mobile telecommunication terminal 1 exists. And a Pilot (2) 24 signifying electric field strength of a pilot signal of the radio speech path 21 between the radio base station 20 and the mobile telecommunication terminal 1 exists. And a Pilot (3) 34 signifying electric field strength of a pilot signal of the radio speech path 31 between the radio base station 30 and the mobile telecommunication terminal 1 exists.

Further, a FER (1) 15 signifying upstream speech quality of the radio speech path 11 using between the radio base station 10 and the mobile telecommunication terminal 1 exists. And a FER (2) 25 signifying upstream speech quality of the radio speech path 21 using between the radio base station 20 and the mobile telecommunication terminal 1 exists. And a FER (3) 35 signifying upstream speech quality of the radio speech path 31 using between the radio base station 30 and the mobile telecommunication terminal 1 exists.

As mentioned above, the embodiment of the CDMA mobile telecommunication system of the present invention provides the mobile telecommunication terminal 1 in the service area overlapped the individual service areas 12, 22, 32 of the respective radio base stations 10, 20, 30, and the radio base station controller 100 that controls the radio base stations 10, 20, and 30.

Next, referring to FIG. 6, the radio base station controller 100 at the embodiment of the CDMA telecommunication system of the present invention is explained. As shown in FIG. 6, the radio base station controller 100 consists of a controller 70, a radio speech path controller 71, a control signal controller 72, a signal transmitter and receiver 73, and radio speech path information storage 74.

The signal transmitter and receiver 73 transmits and receives information regarding speech signals and control signals to and from the radio base stations 10, 20, and 30, through the respective wire transmission lines 13, 23, and 33.

The radio speech path controller 71 memorizes a predetermined frame quality threshold value for securing speech quality and monitors the FERs of respective upstream radio speech paths of the radio speech paths 11, 21, and 31 through the signal transmitter and receiver 73 in a predetermined cycle, and compares the monitored FERs with the frame quality threshold value and outputs the compared results to the controller 70, in order to control the radio speech paths 11, 21, and 31, when the radio speech paths 11, 21, and 31 are established between the mobile telecommunication terminal 1 in the service area overlapped the service areas 12, 22, and 32, and the radio base stations 10, 20, and 30 managing the respective service areas 12, 22, and 32 that are bases of the overlapped service area.

The controller 70 memorizes a predetermined speech level threshold value, and compares the electric field strength of the pilot signals of the downstream radio speech paths of the radio speech paths 11, 21, and 31 with the predetermined speech level threshold value, only when a radio speech path whose FER exceeded the frame quality threshold value exists in the radio speech paths 11, 21, and 31 based on the compared results at the radio speech path controller 71, in order to secure the speech quality of the downstream radio speech paths, and decides that the radio speech path whose FER is the worst is as the hand-off by the jointed compared results of the compared result of the FERs at the radio speech path controller 71 and the compared result of the electric field strength at the controller 70, and informs the control signal controller 72 of the decided result.

The radio speech path information storage 74 memorizes the using state of the radio speech paths 11, 21, and 31 in a designated table in a time series by the control of the controller 70.

The control signal controller 72 transmits a control signal signifying the hand-off to the radio base station having the radio speech path that is decided to be hand-off at the controller 70 through the signal transmitter and receiver 73.

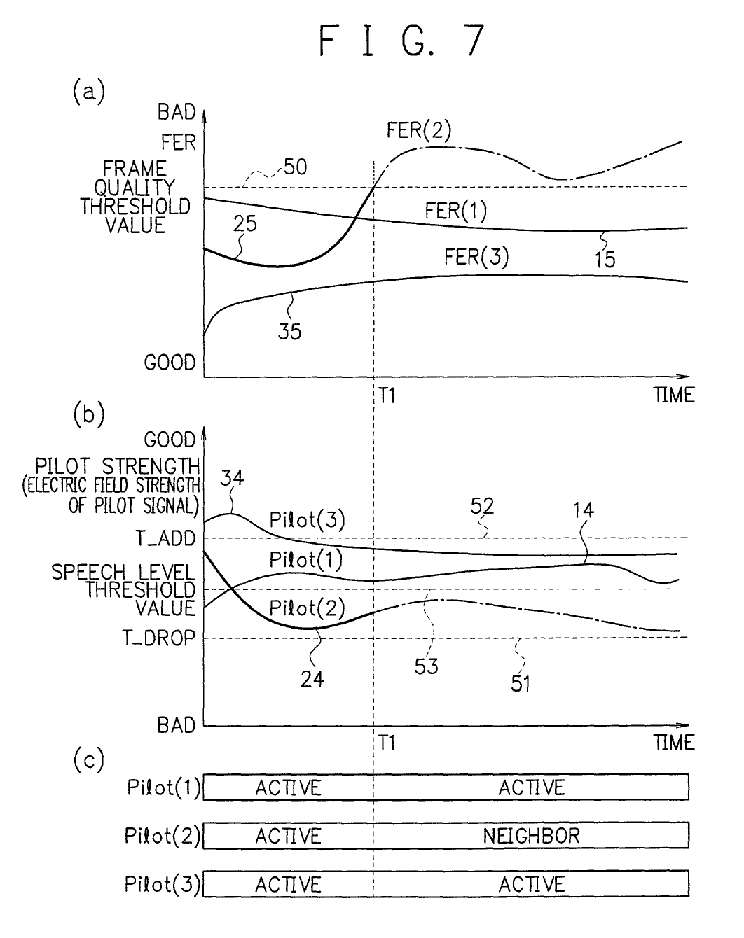

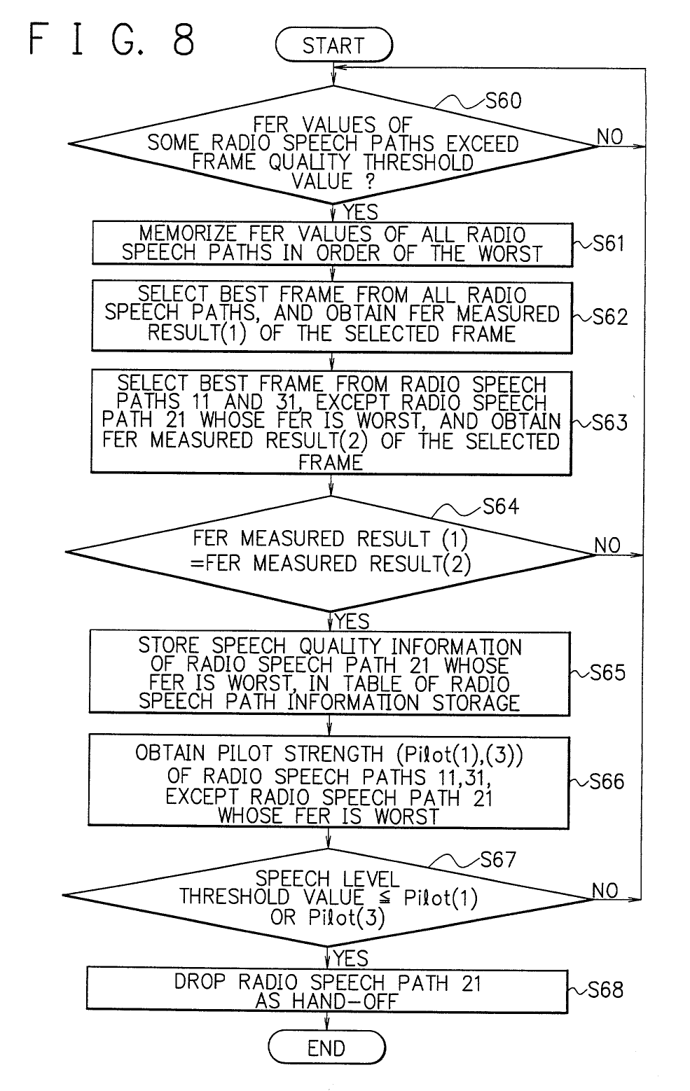

FIG. 7 is a diagram showing quality data of each of the radio speech paths between each of the radio base stations and the mobile telecommunication terminal and also showing a using state of each of the radio speech paths, in a time series at the embodiment of the CDMA mobile telecommunication system of the present invention. In FIG. 7, (a) shows frame quality of each of the radio speech paths in the change of the FERs, ( b ) shows changes of the electric field strength of the pilot signals at each of the radio speech paths, and ( c ) shows the using state of each of the radio speech paths based on the result shown in ( a ) and ( b ). FIG. 8 is a flowchart showing processes of hand-off control at the radio base station controller of the embodiment of the CDMA mobile telecommunication system of the present invention.

In FIG. 7 (a), at the embodiment of the present invention, the FERs are transmitted from the radio base stations 10, 20, and 30 to the radio speech path controller 71 in the radio base station controller 100 through the wire transmission lines 13, 23, 33. That is, the radio speech path controller 71 receives the FER (1) 15, the FER (2) 25, and the FER (3) 35 being frame quality as the speech quality of each of the upstream radio speech paths of the radio speech paths 11, 21, and 31 between each of the radio base stations 10, 20, and 30 and the mobile telecommunication terminal 1 in a time series in a predetermined cycle, and memorizes the received the FERs, and compares the received FERs with a predetermined frame quality threshold value 50.

In FIG. 7 (b), at the embodiment of the present invention, the controller 70 in the radio base station controller 100 receives the Pilot (1) 14, the Pilot (2) 24, and the Pilot (3) 34 from the radio base stations 10, 20, and 30 through the respective wire transmission lines 13, 23, and 33. That is, only when a radio speech path whose FER exceeded the frame quality threshold value 50 exists in the radio speech paths 11, 21, and 31, the Pilot (1) 14, the Pilot (2) 24, and the Pilot (3) 34 signifying the electric field strength of the respective pilot signals as the speech quality of the downstream radio speech paths of the radio speech paths 11, 21, and 31 between the radio base stations 10, 20, and 30 and the mobile telecommunication terminal 1 are measured, and the measured results are memorized in the controller 70. At the example of FIG. 7 (a), the FER (2) 25 exceeds the frame quality threshold value at the time T1, therefore, actually the pilot (2) 24 in FIG. 7 (b) is not measured after the time T1, and this is explained later. A predetermined speech level threshold value 53 is between a radio speech path drop threshold value T_DROP 51 signifying to drop a radio speech path and a radio speech path add threshold value T_ADD 52 signifying to add a radio speech path. And this speech level threshold value 53 is used for judging whether the downstream speech level is satisfied or not. The controller 70 compares these threshold values with the electric field strength of the pilot signals.

In FIG. 7 (c), at the embodiment of the present invention, the radio speech path information storage 74 memorizes the using state of the radio speech paths 11, 21, and 31 in the designated table at the time T of ( a ) and ( b ) of FIG. 7, based on the compared results of the speech quality at the controller 70.

Next, referring to FIGS. 5 to 8, a hand-off method at the embodiment of the CDMA mobile telecommunication system of the present invention is explained. In this explanation, the step number signifies the number in FIG. 8.

As shown in FIG. 5, the radio speech paths 11, 21, and 31 are used between the mobile telecommunication terminal 1 that is in the service area overlapped the service areas 12, 22, and 32, and the radio base stations 10, 20, and 30 that manages respective service areas 12, 22, and 32 being the base of the overlapped service area.

First, the signal transmitter and receiver 73 receives the FERs of the upstream radio speech paths of the radio speech paths 11, 21, and 31, which the mobile telecommunication terminal 1 is using, from the radio base stations 10, 20, and 30 through the respective wire transmission lines 13, 23, and 33. And radio speech path controller 71 receives the FERs from the signal transmitter and receiver 73 in a predetermined cycle and compares the received FERs with the predetermined frame quality threshold value 50 shown in FIG. 7 (a). And the radio speech path controller 71 detects, for example, that the FER (2) 25 signifying the FER of the upstream radio speech path of the radio speech path 21 using between the mobile telecommunication terminal 1 and the radio base station 20 at the time T1 shown in FIG. 7 exceeded the frame quality threshold value 50 (step S60). And the radio speech path controller 71 memorizes the FERs of all the radio speech paths 11, 21, and 31 in order of the worst value (step S61).

After this, the radio speech path controller 71 selects the best frame from the received upstream radio speech paths 11, 21, and 31 using between the mobile telecommunication terminal 1 and the radio base stations 10, 20, and 30, and after this, obtains the measured result (1) of the FER of the selected best frame (step S62). Further, the radio speech path controller 71 selects the best frame from the received upstream radio speech paths 11, and 31 using between the mobile telecommunication terminal 1 and the radio base stations 10, and 30, except the radio speech path 21 between the mobile telecommunication terminal 1 and the radio base station 20, which has the FER exceeding the frame quality threshold value 50, and after this, obtains the measured result (2) of the FER of the selected best frame (step S63). And the measured result (1) of the FER and the measured result (2) of the FER are compared (step S64)

When this compared result is the same (YES at the step S64), the radio speech path controller 71 judges that the radio speech quality of the upstream radio speech path of the mobile telecommunication terminal 1 can be secured. And the controller 70 makes the radio speech path information storage 74 store the information of the radio speech path 21 between the mobile telecommunication terminal 1 and the radio base station 20, which exceeded the frame quality threshold value 50, in the designated table in the radio speech path information storage 74 (step S65).

Next, the controller 70 confirms that the information of the radio speech path 21 between the mobile telecommunication terminal 1 and the radio base station 20 is renewed in the designated table in the radio speech path information storage 74 as newest information, in which the information of the radio speech paths exceeded the frame quality threshold value 50 is stored, between the mobile telecommunication terminal 1 and the radio base stations. And the controller 70 obtains the Pilots (1) 14 and (3) 34 signifying the electric field strength of the downstream radio speech paths 11, and 31 using between the mobile telecommunication terminal 1 and the radio base stations 10, and 30, except the radio speech path 21 between the mobile telecommunication terminal 1 and the radio base station 20, which has the FER exceeding the frame quality threshold value 50, through the radio speech path controller 71, the signal transmitter and receiver 73, and the wire transmission lines 13, and 33 (step S66).

Next, the controller 70 compares the Pilots (1) 14 and (3) 34 signifying the electric field strength of the downstream radio speech paths 11, and 31 using between the mobile telecommunication terminal 1 and the radio base stations 10, and 30, with the speech level threshold value 53 shown in FIG. 7 (b). And the Pilots (1) 14 and (3) 34 signifying the electric field strength of the pilot signals of the downstream radio speech paths 11, and 31 using between the mobile telecommunication terminal 1 and the radio base stations 10, and 30, are found to be exceeding the speech level threshold value 53 shown in FIG. 7 (b) at the time T1 (YES at step S67). The controller 70 judges that the downstream speech level can be secured, even if the radio speech path 21, exceeded the frame quality threshold value 50, between the mobile telecommunication terminal 1 and the radio base station 20, is dropped. And the controller 70 drops the radio speech path 21 between the mobile telecommunication terminal 1 and the radio base station 20 as the hand-off (step S68).

At the conventional CDMA telecommunication system, only pilot signals being the electric field strength of the downstream radio speech paths are measured, and the hand-off of the radio speech paths are decided. However, at the present invention, the FERs of the upstream radio speech paths are measured in addition to that the pilot signals being the electric field strength of the downstream radio speech paths are measured. With this, the hand-off of a radio speech path can be executed smoothly.

As mentioned above, when the controller 70 judges that the radio speech path 21 between the mobile telecommunication terminal 1 and the radio base station 20 is dropped as the hand-off, the controller 70 informs the control signal controller 72 of this judgment. The control signal controller 72 received this information transmits a signal signifying that the radio speech path 21 is dropped as the hand-off to the radio base station 20 through the signal transmitter and receiver 73 and the wire transmission line 23. With this, the mobile telecommunication terminal 1 makes the radio speech path 21 to the radio base station 20 be the hand-off.

As mentioned above, according to the present invention, a mobile telecommunication system, which provides telecommunication service to plural mobile telecommunication terminals, provides plural radio base stations having a respective individual service area, plural mobile telecommunication terminals existing in the plural service areas, and a radio base station controller controlling the plural radio base stations. And there is a case that a mobile telecommunication terminal is in a service area overlapped plural service areas of the plural radio base stations, and plural radio speech paths, between the mobile telecommunication terminal and the plural radio base stations managing their individual service areas and being the base of the overlapped service area, are formed. At this case, at some radio speech paths in the plural speech paths for the mobile telecommunication terminal, when their FERs (frame error rates) being upstream speech quality of upstream radio speech paths exceed a predetermined frame quality threshold value, frames are selected from the upstream radio speech paths excluded the radio speech paths that exceeded the frame quality threshold value and the FERs of the selected frames are measured, and the radio base station controller judges that radio speech quality of the upstream radio speech paths of the mobile telecommunication terminal can be secured by this measured results. And the radio base station controller stores information of the radio speech paths exceeded the frame quality threshold value in a designated table in radio speech path information storage. And at radio speech quality of downstream radio speech paths in the radio speech paths that are used by the mobile telecommunication terminal except the radio speech paths exceeded the frame quality threshold value, when some radio speech paths exceeding the predetermined speech level threshold value exist, some radio speech paths exceeding the frame quality threshold value are dropped as a hand-off based on the information of the radio speech paths exceeded the frame quality threshold value stored in the designated table. With this, the radio speech paths that do not influence the speech quality can be dropped, and the deterioration of the speech quality in the mobile telecommunication system caused by the interference generated by using the radio speech paths that do not influence the speech quality can be prevented.

Moreover, dropped radio speech paths can be allocated to new mobile telecommunication terminals, therefore the efficiency using the radio resources can be improved. Further, at the radio base station controller that currently processes frames received from the radio speech paths whose FERs are bad, the load for the radio base station controller can be reduced by dropping the radio speech paths whose FERs are bad.

While the present invention has been described with reference to the particular illustrative embodiment, it is not to be restricted by that embodiment but only by the appended claims. It is to be appreciated that those skilled in the art can change or modify the embodiment without departing from the scope and spirit of the present invention.

What is claimed is:

1. A mobile telecommunication system, which provides plural radio base stations having a respective individual service area, plural mobile telecommunication terminals existing in said service areas, and a radio base station controller that controls said plural radio base stations, and provides telecommunication service to said plural mobile telecommunication terminals, wherein:
at the case that one of said plural mobile telecommunication terminals is in a service area overlapped said plural service areas of said plural radio base stations, and plural radio speech paths between said one of said plural mobile telecommunication terminals and said plural radio base stations, which manage their individual service areas and are the bases of the overlapped service area, are formed, said radio base station controller, comprising:
a monitoring means for monitoring FERs (frame error rates) signifying frame quality of respective upstream radio speech paths of said plural radio speech paths for said one of said plural mobile telecommunication terminals in a predetermined constant cycle; and
a judging means, which detects some radio speech paths whose FERs of said upstream radio speech paths exceeded a predetermined frame quality threshold value based on monitored results at said monitoring means, in order to judge that speech quality of several upstream radio speech paths in all said plural radio speech paths using between said one of said plural mobile telecommunication terminals and said plural radio base stations can be sufficiently secured, and removes said upstream radio speech paths, whose FERs exceeded said frame quality threshold value, from said plural radio speech paths using between said one of said plural mobile telecommunication terminals and said plural radio base stations, and selects the best frames from said upstream radio speech paths removed radio speech paths exceeded said frame quality threshold value, and judges whether said upstream radio speech paths of said one of said plural mobile telecommunication terminals can be secured or not by using the measured result of said FERs from said selected best frames.

2. A mobile telecommunication system in accordance with claim 1, wherein:
said radio base station controller, further comprising:
a storing means for storing information of said upstream radio speech paths whose FERs exceeded said frame quality threshold value in a designated table, when upstream radio speech quality of said one of said plural mobile telecommunication terminals is judged to be able to secure even if said upstream radio speech paths whose FERs exceeded said frame quality threshold value are removed from all said upstream radio speech paths using between said one of said plural mobile telecommunication terminals and said plural radio base stations.

3. A mobile telecommunication system in accordance with claim 2, wherein:
said radio base station controller, further comprising:
a speech level confirming means for confirming speech levels of downstream radio speech paths of remaining all said radio speech paths removed said radio speech paths whose FERs exceeded said frame quality threshold value by referring to said designated table by electric field strength of pilot signals transmitted from said plural radio base stations connected to said one of said plural mobile telecommunication terminals, when said designated table in said storing means, which stores said information of said upstream radio speech paths whose FERs exceeded said frame quality threshold value, is renewed; and
a control means for judging that the downstream radio speech level of said one of said plural mobile telecommunication terminals can be secured even if said radio speech paths whose FERs exceeded said frame quality threshold value are removed, at the case that at least one radio speech path whose electric field strength of said pilot signal exceeded a predetermined speech level threshold value exists in said downstream radio speech paths.

4. A mobile telecommunication system in accordance with claim 3, wherein:
said radio base station controller, further comprising:
a radio speech path dropping means for dropping said radio speech paths whose FERs exceeded said frame quality threshold value as a hand-off based on said information of said radio speech paths whose FERs exceeded said frame quality threshold value stored in said designated table in said storing means, by judging that said downstream radio speech path of said one of said plural mobile telecommunication terminals can be secured even if said radio speech paths whose FERs exceeded said frame quality threshold value are removed, at the case that at least one radio speech path whose electric field strength of said pilot signal exceeded said predetermined speech level threshold value exists in said remaining downstream radio speech paths, excluded said radio speech paths whose FERs exceeded said frame quality threshold value, using between said one of said plural mobile telecommunication terminals and said plural radio base stations.

5. A mobile telecommunication system, which provides plural radio base stations having a respective individual service area, plural mobile telecommunication terminals existing in said service areas, and a radio base station controller that controls said plural radio base stations, and provides telecommunication service to said plural mobile telecommunication terminals, wherein:
said radio base station controller, comprising:
a signal transmitter and receiver that transmits and receives information regarding speech signals and control signals to and from said plural radio base stations through respective wire transmission lines;
a radio speech path controller that memorizes a predetermined frame quality threshold value for securing speech quality and monitors FERs of respective upstream radio speech paths of plural radio speech paths through said signal transmitter and receiver in a predetermined cycle, and compares said monitored FERs with said frame quality threshold value, and outputs said compared results, in order to control said plural radio speech paths at the case that said plural radio speech paths are established between one of said plural mobile telecommunication terminal in a service area overlapped said service areas and said plural radio base stations managing the respective service areas that are bases of said overlapped service area;
a controller that memorizes a predetermined speech level threshold value, and compares electric field strength of pilot signals of downstream radio speech paths of said plural radio speech paths with said predetermined speech level threshold value in order to secure speech quality, only when radio speech paths whose FERs exceeded said frame quality threshold value exist in said plural radio speech paths at said compared results at said radio speech path controller, and decides that a radio speech path whose FER is the worst is as a hand-off by the jointed compared results of said compared result of said FERs at said radio speech path controller and said compared result of said electric field strength at said controller, and outputs said decided result;
radio speech path information storage that memorizes the using state of said plural radio speech paths in a designated table in a time series by the control of said controller; and
a control signal controller that transmits a control signal signifying the hand-off to radio base stations having a radio speech path that is decided to be hand-off at said controller through said signal transmitter and receiver.

6. A hand-off method of radio speech paths at a mobile telecommunication system, which provides plural radio base stations having a respective individual service area, plural mobile telecommunication terminals existing in said service areas, and a radio base station controller that controls said plural radio base stations, and provides telecommunication service to said plural mobile telecommunication terminals, wherein:
said radio base station controller, comprising the steps of at the case that plural radio speech paths are established between one of said plural mobile telecommunication terminal in a service area overlapped said service areas and said plural radio base stations managing the respective service areas that are bases of said overlapped service area,
monitoring upstream speech quality of upstream radio speech paths of plural radio speech paths for said one of said plural mobile telecommunication terminals by their FERs in a predetermined cycle;
comparing said monitored FERs with a predetermined frame quality threshold value;
selecting the best frames of upstream radio speech paths whose FERs did not exceed said predetermined frame quality threshold value when said FERs of some of said upstream radio speech paths exceeded said predetermined frame quality threshold value;
judging that radio speech path quality of said upstream radio speech paths of said one of said plural mobile telecommunication terminals can be secured by the measured result of said FERs from said selected frames;
storing information of said radio speech paths whose FERs exceeded said frame quality threshold value in a designated table;
monitoring downstream speech levels of downstream radio speech paths of said plural radio speech paths excluded said radio speech paths whose FERs exceeded said frame quality threshold value for said one of said plural mobile telecommunication terminals by measuring electric field strength of pilot signals transmitted from said plural radio base stations only when a radio speech path whose FER exceeded said frame quality threshold value exists;
comparing said electric field strength of said pilot signals of remaining plural radio speech paths excluded said radio speech paths whose FERs exceeded said frame quality threshold value with a predetermined speech level threshold value;
judging that the downstream radio speech level of said one of said plural mobile telecommunication terminals can be secured even if said radio speech paths whose FERs exceeded said frame quality threshold value are removed, at the case that at least one radio speech path whose electric field strength of said pilot signal exceeded said predetermined speech level threshold value exists in said downstream radio speech paths; and
dropping said radio speech paths whose FERs exceeded said frame quality threshold value as said hand-off, based on said information stored in said designated table.
